(19) United States
(12) Patent Application Publication
(10) Pub. No.: US 2025/0184160 A1
(43) Pub. Date: Jun. 5, 2025

(54) SECURED ACCESS SYSTEM

(71) Applicant: Barix AG, Zürich (CH)

(72) Inventor: Johannes RIETSCHEL, Zürich (CH)

(73) Assignee: Barix AG, Zürich (CH)

(21) Appl. No.: 18/864,448

(22) PCT Filed: May 5, 2023
(86) PCT No.: PCT/EP2023/061904

§ 371 Date: Nov. 8, 2024

(30) Foreign Application Priority Data
May 10, 2022 (EP) 22172558.3

(51) Int. Cl. H04L 9/32; H04W 12/0433; H04W 12/069; H04W 12/50

(52) U.S. Cl. CPC H04L 9/3271; H04W 12/0433; H04W 12/069; H04W 12/50

(57) ABSTRACT

A method is for releasing a communication connection between a mobile device and another device, and for an exchange of data between the other device and a server. The method includes sending a communication request to the other device; transmitting an encrypted challenge to the mobile device; transferring the challenge to the server, in the form an authentication server, and checking the access authorization or, if the access authorization is absent, generating an encrypted authentication, and if the access authorization is provided, generating an encrypted authentication and carrying out the following: transferring the encrypted authentication to the mobile device; transmitting the encrypted authentication to the device; and checking the access authorization on the basis of the encrypted authentication, and if the access authorization is absent, outputting a respective transmission to the mobile device, and if the access authorization is provided, releasing the exchanged data.

### TECHNICAL FIELD

The present invention relates to a method and a system for secure access to an electrical or electronic device.

### PRIOR ART

Cyber attacks on infrastructure are becoming more and more sophisticated. More and more often not only servers but also IoT (Internet of Things) devices are falling victim to attacks. Once a hacker has penetrated a device, from this device they can often remain unrecognized as they attack further, in that case local targets, send covertly observed data from the network (even in an encrypted manner), etc.

The local (initial) device configuration of such devices is therefore a very critical aspect. Often it is also necessary at later times, on the devices, to carry out certain functions such as e.g. reconfigurations, to start firmware updates, etc.

One customary way of implementing such functions on devices is a web server. The latter is then protected by password, secure connections (https etc.) so that an unauthorized access is prevented if possible.

Certificate management with the devices is laborious, and even with encrypted access it is still necessary to undergo authentication vis-à-vis the device.

If access passwords fall into the wrong hands, they can be used at any time to make changes on the device.

Often the devices (with justification) are prohibited from setting up connections to the Internet. A possible access authorization can therefore be checked only locally.

The use of private/public keys, asymmetric encryption, is complex and often infeasible for IoT devices, particularly if they do not have online access and are thus also not able to check the authenticity of a server certificate at all.

WO-A-2021099063 relates to a method for the reconfiguration of an IoT device, wherein the IoT device is connectable to a cloud backend via a network. The method comprises the following preparatory steps:—storing an access code to be input locally in the cloud backend and—storing the access code or check information formed depending thereon on the IoT device. The method furthermore comprises the following steps for reconfiguring the IoT device:—requesting the access code from the cloud backend, —inputting the requested access code at a local configuration interface of the IoT device or at an input device connected to the local configuration interface of the IoT device, —comparing the access code that has been input with the access code stored on the IoT device or with the check information formed depending thereon, and—enabling the IoT device for reconfiguration in the event of a positive comparison between the access code that has been input and the access code stored on the IoT device or the check information formed depending thereon.

US2014273824 describes systems, apparatuses and methods which are configured to facilitate the coupling of an implantable device with a remote device using a near field communication (NFC) device attached to the implantable device. In one aspect, an implantable apparatus assembly comprises an implantable apparatus and an NFC component externally attached to the implantable apparatus. The NFC component is configured to transmit identification information associated with the implantable device to a reader using the NFC protocol. The transmission takes place as a response to a received request signal.

US2016050565 describes techniques for securely provisioning a client device. A client device may output first client information over a secure interface to a trustworthy device in order to be transmitted to an authentication server. Second client information related to the first client information may be transmitted to the authentication server. The authentication server may link the second client information and the first client information. The client device may receive an encrypted authentication credential from the authentication server. The authentication credential may be encrypted based at least in part on the first client information or the second client information. The client device may decrypt the encrypted authentication credential using the first client information, the second client information, or a shared secret key.

### SUMMARY OF THE INVENTION

Accordingly, it is an object of the present invention, inter alia, to provide an improved and secure but nevertheless simple and reliable possibility of access to devices, in particular to devices which are not permanently on the Internet, or not on the Internet at all. In this case, the access is intended to be effected via a mobile device or only by means of a mobile device by way of a server or respectively from a server. The connection between the device and a server is then mediated by means of a mobile device (cellular phone) having an Internet access. The mobile device itself possibly does not need an authorization; the communication between device and server takes place in an encrypted manner by way of or respectively via the mobile device.

This object is achieved by a method as claimed in claim 1.

Specifically, what is involved is a method for enabling a communication connection between a mobile device and a further device, in particular for data exchange between the further device (G) and a server (AS), both devices, i.e. the mobile device (MG) and the further device (G), having a common interface for data exchange.

The method is characterized by the following steps in the specified order:
sending a communication request to the further device by means of the mobile device via the interface;
transmitting an encrypted challenge from the further device to the mobile device via the interface;
transferring the encrypted challenge from the mobile device via a data connection to the server as authentication server, at which the user of the mobile device has logged on (the logon at the authentication server may already have taken place before the communication request was sent to the further device, or can take place in the context of transferring the encrypted challenge, and is optional);
checking the access authorization in the authentication server on the basis of the encrypted challenge.

If, during this checking, the authentication server ascertains that no access authorization is provided, a corresponding message is output to the mobile device for the purpose of outputting to the user and/or the communication is terminated by the authentication server, which is then recognized as non-authentication by the data processing program of the mobile device.

If the access authorization is absent, the generation of an encrypted authentication by the authentication server is also possible, the content of which is an absent authentication.

If the access authorization is provided, an encrypted authentication is generated.

If such an authentication is generated (whether with the content of the absent authentication or with the content of the provided authentication), the following steps follow in the specified order:
transferring the encrypted authentication from the authentication server to the mobile device via the data connection;
transmitting the encrypted authentication from the mobile device to the device via the interface;
checking the access authorization in the device on the basis of the encrypted authentication, and
if the access authorization is absent, outputting or transmitting a corresponding message to the mobile device,
if the access authorization is provided, enabling the data exchange between the mobile device (MG) and the further device (G) and/or the data exchange between the further device (G) and the server (AS) via the mobile device (MG) within the scope of the authentication.

The secure connection for the exchange of data between the device and the server by means of an encrypted tunnel can be effected through the mobile. The user of the mobile device may then have logged on at the server and may also communicate with the tunneled device via the server if that is authorized, but the method may also be structured so that there is no direct connection at all between the user (on their mobile device) and the device.

The major advantage of this method is that substantially the entire securing can take place at the time of setting up the further device by virtue of the corresponding keys being stored on the device and on the authentication server. The corresponding information can also be stored in a public blockchain as server, optionally together with further data characterizing the device, such as for example the latter's age, delivery state, version, invoicing, owner, delivery date. Further parameters of this type are parameters which control or supervise the device, but also the software version, etc.

A further major advantage of the proposed method is that device-specific passwords are not required, rather only an authorization for the logon at the authentication server is required from the user. Moreover, the proposed method affords the advantage that on the authentication server the access can be specifically defined by an administrator, namely for specific users, specific devices, specific time windows, etc. The communication depth can also be defined; by way of example, for a specific user in a specific time window only the readout of data may be made possible, but not changing the configuration of the device or updating the software, etc.

Preferably, the data exchange between the further device and the server is effected via the mobile device, and parameters which supervise the further device and are stored on the server, or are applied to the server by the user of the mobile device, are written to the further device (G) from the server via the mobile device. This preferably takes place without direct and/or indirect influencing by the user and furthermore preferably with logging of the data transmission via a display of the mobile device (MG) to the user.

The advantages of this procedure are inter alia as follows:
there is no possibility for a user to configure the device locally without a server connection and thus to introduce a non-synchronized parameter status into the device (prevention of an undocumented system change);
the tunnel made via the mobile device can be temporarily created even by a totally uninvolved party (e.g. a training technician who does not know the devices at all) via their mobile device in order that a “remote” technician can configure and maintain the device online;
or a technician can prepare a new configuration, which then distribute by the on-site employee without change authorizations to the devices G by production of the tunnel;
each change to the device is documented both in terms of who made it and when (on the server) and in terms of when it was transferred into the device G via the tunnel via a mobile device MG (and optionally, if the user of the mobile device MG needs to actively log in, who that was).

The device is already known “at birth” and, accordingly, a “shared key” or, put more generally, key material can be written to the device directly in the factory. Ultimately, public/private key methods are preferably used actually only in order to negotiate a session key securely.

Therefore, preferably during production, the device is preferably equipped with an individual “shared secret”, which is simultaneously stored in a secure data memory, blockchain, etc., for later use by the portal (authentication server).

In the device, at the time of production, a counter is preferably also initialized (e.g. set to 1 as initial value), and this value is likewise stored for the portal. This counter is helpful for identifying “playback” attacks, but is not absolutely necessary.

Standardized certificates can also be used as an alternative to a “shared secret”.

The “index” for the key information on the server may be an invariable serial number of the device.

During connection setup, typically first of all the authenticity of the mediator (mobile device) is checked (this is usually done e.g. by means of a client certificate and/or user login).

The mediator will then typically request a specific data set from the device, namely
device ID
sequence number S1
challenge C1 (random number generated in the device)

These data are preferably sent from the mediator to the server.

The server can then use the device ID as a basis to check whether the mediator (user) is authorized for access to this device.

If so, it will preferably calculate a cryptogram K1 by way of challenge C1 and sequence number S1 with the device-specific “secret” and transmit this cryptogram together with a random number/challenge C2 generated by the server to the mediator for relaying.

The device, if it obtains the data set (cryptogram K1, random number C2) from the server, can check the authenticity of the server (is the cryptogram K1 correctly calculated) and for its part, by way of the random number C2 transmitted by the server, can calculate a cryptohash K2 and return this to the server via the mediator.

Then the server can also check the authenticity of the device on the basis of the hash K2 and the server-mediator-device association is authenticated.

In one preferred embodiment, the mediator will carry out the communication with the server via an encrypted, secure communication interface (e.g. web socket) and the communication between mediator and device will be effected e.g. via an independent encryption or a direct wire connection.

The order of the authentications can also be reversed.

Both sides may preferably also log non-authenticated attempts and accordingly prevent brute force attacks using back-off algorithms.

The basic principle is preferably always that the device authenticates itself (via the mediator) at the server and the server also authenticates itself at the device via the mediator, unequivocally with the aid of cryptographic methods.

The data exchange that then follows should preferably be effected via a connection encrypted by the mediator, but an end-to-end encryption between server and device can be set up with the aid of the “shared secret” by means of known methods.

In this case, e.g. the following storage structures are used:

The following data (preferably at least two thereof, more particularly preferably all of them) are kept in the device:
device ID
shared secret
sequence number (is increased upon each authentication carried out)
challenge (volatile, is kept only until the checking of the cryptogram returned from the server)

The following (preferably at least two thereof, more particularly preferably all of them) in the server or swapped to an external blockchain:
shared secret, per device, indicated by the device IDs
last sequence number
last access date, counter for successful and unsuccessful connections etc. (statistics)
generated challenge (volatile, is kept only for the checking of the cryptogram returned from the device). One preferred embodiment of the proposed method is characterized in that the common interface is a wireless interface, preferably a Bluetooth, BLE, WLAN, NFC, RFID, radio connection, or else sound (sound via loudspeaker/microphone, sounds in the audible and/or non-audible range) interface.

The method is furthermore preferably characterized in that the common interface is a wired interface, preferably a serial interface, a USB interface, Ethernet, CAN bus or other available local interfaces (including I2C).

Besides the pure authorization information, the authentication, as mentioned further above, can include information about the scope of the authorization, in particular user information, time information (duration of the access, beginning of the access, end of the access), permitted intervention depth.

When checking the access authorization in the authentication server, it is possible to take into account not just the encrypted challenge but additionally information about the mobile device, preferably in the form of hardware-specific and individualized information, and/or information about the user logged on at the mobile device and/or at the authentication server, and/or information from a token of such a user.

The mobile device is typically a laptop or a cellular phone. Preferably, the method is furthermore characterized in that within the scope of the enabled data exchange, data are read from the memory of the further device (for example data that were recorded by a sensor at a previous time and were logged, e.g. the content of an error message memory), an update is loaded on the device, the device is reconfigured, or a combination thereof.

The further device typically comprises at least the mentioned interface and also a data processing unit with memory, and also at least one further functionality, in particular a sensor, an output interface, in particular a display, or a loudspeaker, or a combination of such functionalities. This may involve a complex device such as a printer or an industrial robot, for example; however, this may also involve quite simple devices in the sense of IoT devices, comprising just a sensor, for example.

On the authentication server and the device, private keys for the generation of challenge and respectively authentication and the verification of this encrypted information are typically present, and also preferably corresponding associated public keys on the respective other device.

In order to increase security, the device may also use an incrementing number, and it is furthermore possible to keep a plurality of keys available (on both sides), which are then changed either randomly or after a specific time and/or after a specific number has been reached.

The keys, optionally together with hardware-specific and individualized information of the device, may be stored on a public blockchain.

If the challenge leads to a non-authorization during checking on the authentication server, in accordance with a further preferred embodiment the authentication server can transmit an authentication to the mobile device, which either is recognized as non-authorization directly at the mobile device and leads to the outputting of a corresponding message to the user at the mobile device, or the authentication can be transmitted to the further device, and on the latter a corresponding output can be output or such an authentication can be transmitted back from the further device to the mobile device for the output. It may be expedient here to notify the device of the invalid authentication in order that e.g. after a specific number the device blocks attempts for some time.

With preference, an identifier, preferably in the form of a barcode or a QR code, can additionally be provided on the further device, which identifier can be read out by the mobile device, for example by means of a camera, and is used for the identification of the further device and for the communication with the authentication server by virtue of the corresponding device identifier being transmitted together with the challenge to the authentication server.

Furthermore, the present invention relates to a system for carrying out a method as described above, wherein the system comprises at least one authentication server, at least one mobile device and at least one further device, preferably a plurality of further devices, and wherein a data connection is present between authentication server and mobile device, and the mobile device and the further device comprise at least one common interface for data exchange. Data processing software that implements the proposed method is additionally provided on each of the various components.

Accordingly, the present invention also relates to a data processing program, preferably on a data memory, for carrying out a method as described above, wherein the data processing program communicates on the mobile device with an output interface, preferably in the form of a display of the mobile device for communication with the user.

Further embodiments are specified in the dependent claims.

### BRIEF DESCRIPTION OF THE DRAWINGS

Preferred embodiments of the invention are described below with reference to the drawings, which serve merely for explanation and should not be interpreted as limiting. In the drawings:

FIG. 1 schematically shows the step-by-step authentication process at a device.

### DESCRIPTION OF PREFERRED EMBODIMENTS

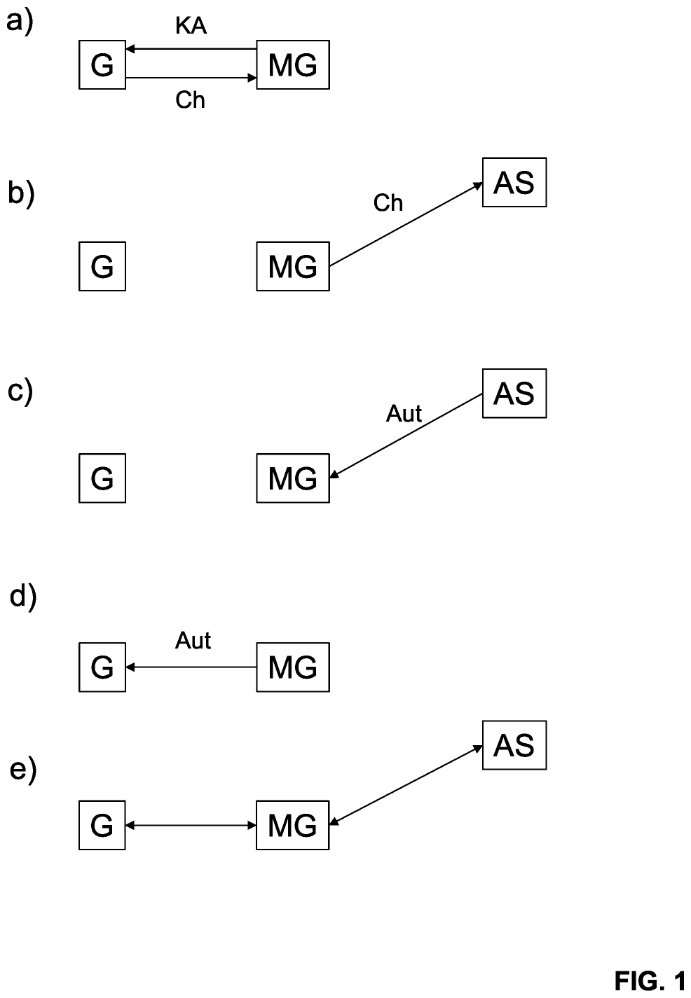

FIG. 1 schematically represents the method proposed here for the authentication of a mobile device MG at a local device G.

A prerequisite for the method is that, on an authentication server AS, a data structure is stored which makes it possible to be able to verify encrypted verification information provided by the device G, this verification information being referred to hereinafter as challenge Ch, and to be able to provide an authentication Aut upon verification. Besides the actual authentication in the sense of the information for supervising the enabling of the access, the authentication can also include even further information, thus for example the duration of the enabled access, the scope of the enabled access (down to what intervention depth), the amount of enabled data to be exchanged, etc.

A further prerequisite for the method is that, on the device G, a data structure is stored which in turn makes it possible, after setting up a communication request KA from a mobile device MG, to provide encrypted verification information, the challenge. Furthermore, the data structure on the device makes it possible to check an authentication Aut provided by the authentication server and, in the case of a positive checking result, to enable the device G for the communication with the mobile device MG within the scope of the authentication Aut. If, besides the actual supervision of the enabling of the access, the authentication Aut also includes even further information such as for example the duration of the enabled access, the scope of the enabled access, etc., then the device G correspondingly enables the communication.

A device G within the meaning of the present invention is a device which provides in any case via an interface for exchanging information with a mobile device, for example in the form of a wireless communication connection, for example Bluetooth, Bluetooth Low Energy, WLAN (IEEE 802.11), but also in the form of a wired connection, for example in the form of a USB connection, a serial interface. Furthermore, the device has a data processing unit (CPU) with possibility of storage, which is linked to the interface, and also at least one further functionality which constitutes the actual device, for example a sensor, an output interface (for example loudspeaker, display), but this may also involve a robot device or the like which performs specific automated tasks. Furthermore, the device G has a power supply (for example in the form of a battery, a rechargeable battery or a wired power supply).

The device G may, but need not, have directly or indirectly an Internet connection. If such an Internet connection is present, it can be implemented for transmitting data which the device generates, or is intended to receive, to a cloud backend. The data may in this case be transferred to the Internet or respectively received therefrom via a WLAN or a similar connection via a server. However, the device also need not have such a connection; the method is in particular also characterized in that it functions without a connection to a cloud backend.

The authentication server AS is a cloud backend that can be contacted by the mobile device MG via an Internet connection or a cellular phone connection.

Under these boundary conditions, the following method for enabling access to the device G is now possible, for example if the intention is to perform maintenance work or new configurations on the device G. For this purpose, the corresponding person with their mobile device MG having a communication interface corresponding to that on the device G approaches the device G and, typically by way of authentication software specifically provided for this purpose, sets up a communication connection KA to the device (FIG. 1 a) upper arrow).

The device G is now configured so that, in response to the corresponding request from the authentication software, the device does not wait for the input of an access code or the like, but rather transmits the aforementioned challenge Ch, i.e. encrypted verification information, to the mobile device MG (FIG. 1 a) lower arrow).

This challenge Ch is then not verified or processed in the mobile device MG, but rather transmitted without being changed to the authentication server AS via a wireless data connection provided in the mobile device MG (FIG. 1 b)). This transmission is enabled by the authentication server AS only if the corresponding user of the mobile device MG has validly logged on at the authentication server.

It is only on the latter that the challenge Ch is then checked. If the authentication server AS ascertains that the mobile device MG or the user thereof or both is/are authorized to access the device G, the authentication server transmits an authentication Aut to the mobile device MG (FIG. 1 c)).

This authentication Aut is in turn transmitted without being changed from the mobile device via the local interface (FIG. 1 d)).

The device G thereupon checks the authentication Aut, and if the checking is positive, the communication defined within the scope of the authentication is enabled (FIG. 1 e)).

On the authentication server, accordingly, time windows can be defined and users and authorized access devices can be defined, such that the authentication is effectively issued only within the scope of these stipulations.

In other words, the “secret” required for access to the device is never given to anyone. It resides securely on a cloud service AS.

A technician or owner of the device G has to identify themselves at the cloud service AS using the known methods (including 2FA). Here an administrator may also allocate time windows for an access, for example, such that a technician is permitted to access the device only for a specific time.

The technician is accordingly present locally for example with their mobile device MG. The device G has no network-side access possibilities “open”.

Via a connection locally present (e.g. BLE/Bluetooth/serial etc.), the technician can connect their cellphone as mobile device MG to the device by means of an app, for example.

The device G transfers the challenge Ch to the cellphone.

This challenge is transmitted from the cellphone MG to the cloud service AS at which the user has logged in.

It is only if the user is authorized to work on the specific device at this specific time that the challenge Ch is correctly computed in the cloud server AS and the corresponding response Aut is transmitted to the app (and from the latter to the device).

The device G checks the response on the basis of an individual key agreed with the cloud portal AS and, if this response is OK, access is enabled.

Depending on the application, the employee may then supply configurations or data available on the cloud into the device G, the device may supply data (encrypted) to the cloud service via the employee's cellphone, a web server may be activated, etc.

Generally and independently of the further features in connection with the exemplary embodiment in other words and more particularly preferably the cloud server AS is not only an authentication server but also a general data server provided in particular for the central management of the parameters (including software updates, etc.) on the device G. The user with their mobile device MG, directly by way of their mobile device MG according to the temporal authorization or respectively spatial authorization defined on the cloud server, can communicate with the device G and optionally also influence the device G and change parameters on this device G. Preferably, however, parameters on the device G are not changed at the device G simply independently by way of the mobile device MG, rather it is ensured that the current parameterization of the device G is always present and stored on the cloud server AS. This may either be ensured such that upon the inputting of a parameter by the user on the mobile device MG, the corresponding parameter is simultaneously transferred to the device G and to the server, so that the correct parameters are stored at both locations G and AS, or, preferably, parameters changed for the device G by the user on the mobile device MG are firstly transmitted to the server AS, are written into the parameters stored for the device G in the database of said server, and are subsequently transmitted from the cloud server AS via the mobile device MG to the device G.

Alternatively, it is possible that such parameters for the device G can only be transmitted from the cloud server AS via the mobile device MG to the device G, and on the cloud server AS and the device G cannot actually be changed by the user by way of the mobile device MG, but rather only by way of direct access (e.g. logging in) on the cloud server AS. In this case, the connection setup between the device G and the mobile device MG, in relation to these parameters, serves only as a mediator of a connection between the device G and the cloud server AS in order to make possible the supervision of the device G by means of the cloud server AS or respectively the adaptation of the parameterization, but not to carry out intervening control. In such a structuring, it is also possible for the user at the mobile device MG not to be given any opportunity at all to access the device G directly, apart possibly from passive readout. It is possible in this situation that the mobile device MG of the user, if it is prepared for such actions, with or without further influencing by the user, simply only in the case of local presence in the vicinity of the device G, both sets up the connection to the device G by way of the secure protocol as described above, and afterward the mobile device MG becomes autonomously active as a mediator for the data transmission between the device G and the cloud server AS. The user of the mobile device may then optionally also be informed, by way of corresponding outputs via the display, about what actions were carried out and whether such actions were actually concluded effectively (which may be important if the user might leave the connection area or respectively the range of the connection between the mobile device and the device G).

In other words, the central authentication server or respectively the database (cloud server AS), preferably in the form of a blockchain, primarily as far as the parameters are concerned, regulates the authorizations as to who is permitted, and when, to alter the configuration at what device, observe data and so on (that is done by login of the user at the computer, possibly even with a web browser without a local app etc.).

Preferably, this concerns the time-/location-/device-specific authorization to observe and to change data for the device G, coupled with by chance possibly the same person who is on site and produces the tunnel with their mobile device MG, without necessarily being actively involved.

The advantages of this procedure are as follows:
there is no possibility for a user to configure the device locally without a server connection and thus to introduce a non-synchronized parameter status into the device (prevention of an undocumented system change);
the tunnel can be temporarily created even by a totally uninvolved party (e.g. a training technician who does not know the devices at all) via their mobile device MG in order that a “remote” technician can configure and maintain the device G online;
or a technician can prepare a new configuration, which then distribute by the on-site employee without change authorizations to the devices G by production of the tunnel;
EACH change to the device is documented both in terms of who made it and when (on the server) and in terms of when it was transferred into the device G via the tunnel via a mobile device MG (and optionally, if the user of the mobile device MG needs to actively log in, who that was).

The method can be used quite universally for various devices, which also need not have an Internet connection. It is also suitable e.g. for unlocking automobiles if a key is lost, opening safes, etc.

A basic condition is that, at the device's hour of birth, the device and the cloud service exchanged a jointly known but otherwise confidential “secret” which is needed for the authentication, and access to this secret is granted by the cloud service only after arbitrarily rigid checking of access authorization in the cloud system.

The access data with respect to the device (security/secret) may e.g. also be stored in a public blockchain in order to protect them forever against loss—only the associated key with respect to the encrypted blockchain entries is then necessary (which is managed by the cloud portal, for example).

LIST OF REFERENCE SIGNS

| | |
|---|---|
| AS | Authentication server/ |
| | Data server |
| Aut | Authentication |
| Ch | Challenge |
| G | Terminal device, IoT |
| KA | Communication setup |
| MG | Mobile device |

1. A method for enabling a communication connection between a mobile device and a further device,
the mobile device and the further device having a common interface for data exchange,
wherein said method comprises the following steps in the specified order:
sending a communication request to the further device by means of the mobile device via the interface;
transmitting an encrypted challenge from the further device to the mobile device via the interface;
transferring the encrypted challenge from the mobile device via a data connection to the server as authentication server, at which the user of the mobile device has logged on or at which the user of the mobile device has not logged on;
checking an access authorization in the authentication server on the basis of the encrypted challenge, and
if the access authorization is absent, outputting a corresponding message and/or terminating the communication by means of the authentication server;
or if the access authorization is absent, generating an encrypted authentication (Aut), the content of which is an absent authentication, and
if the access authorization is provided, generating an encrypted authentication (Aut), and the following steps in the specified order:
transferring the encrypted authentication from the authentication server to the mobile device via the data connection;
transmitting the encrypted authentication from the mobile device to the device via the interface;
checking the access authorization in the device on the basis of the encrypted authentication, and
if the access authorization is absent, outputting or transmitting a corresponding message to the mobile device,
if the access authorization is provided, enabling the data exchange between the mobile device and the further device and/or the data exchange between the further device and the server via the mobile device within the scope of the authentication.

2. The method of claim 1, wherein the data exchange between the further device and the server is effected via the mobile device, and parameters which supervise the further device and are stored on the server, or are applied to the server by the user of the mobile device, are written to the further device from the server via the mobile device.

3. The method of claim 1, wherein the common interface is a wireless interface,
and/or in that the common interface.

4. The method of claim 1, wherein besides the pure authorization information, the authentication includes information about the scope of the authorization.

5. The method of claim 1, wherein checking the access authorization in the authentication server takes into account not just the encrypted challenge but additionally information about the mobile device, and/or information about the user logged on at the mobile device and/or at the authentication server, and/or information from a token of such a user.

6. The method of claim 1, that wherein the mobile device is a laptop or a cellular phone.

7. The method of claim 1, wherein within the scope of the enabled data exchange, data are read from the memory of the further device, an update is loaded on the device, the device is reconfigured, or a combination thereof.

8. The method of claim 1, wherein the further device comprises at least the mentioned interface and also a data processing unit (CPU) with memory, and also at least one further functionality.

9. The method of claim 1, wherein on the authentication server and the device, private keys for the generation of challenge and respectively authentication and the verification of this encrypted information are present.

10. The method of claim 9, wherein a plurality of keys are kept available on the authentication server and the device, and are then changed either randomly or after a specific time and/or after a specific number has been reached.

11. The method of claim 9, wherein the keys, alone or together with hardware-specific and individualized information of the device, are stored on a public blockchain.

12. The method of claim 1, wherein, if the challenge leads to a non-authorization during checking on the authentication server, the authentication server transmits an authentication to the mobile device, which either is recognized as non-authorization directly at the mobile device and leads to the outputting of a corresponding message to the user at the mobile device, or in that the authentication is transmitted to the further device, and on the latter a corresponding output is output or such an authentication is transmitted back from the further device to the mobile device for the output.

13. The method of claim 1, wherein an identifier is provided on the further device, which identifier can be read out by the mobile device and is used for the identification of the further device and for the communication with the authentication server by virtue of the corresponding device identifier being transmitted together with the challenge to the authentication server.

14. A system for carrying out a the method of claim 1, wherein the system comprises a server and/or an authentication server, at least one mobile device and at least one further device, and wherein a data connection is present between server and/or authentication server and mobile device, and the mobile device and the further device comprise at least one common interface for data exchange.

15. A data processing program, on a data memory, for carrying out the method of claim 1, wherein the data processing program communicates on the mobile device with an output interface.

16. The method of claim 1, wherein the method is also for data exchange between the further device and a server.

17. The method of claim 2, wherein the data exchange between the further device and the server is effected via the mobile device, and parameters which supervise the further device and are stored on the server, or are applied to the server by the user of the mobile device, are written to the further device from the server via the mobile device, without direct and/or indirect influencing by the user with or without logging of the data transmission via a display of the mobile device to the user.

18. The method of claim 3, wherein the common interface is a Bluetooth, BLE, WLAN, NFC, RFID, and/or sound interface,
and/or in that the common interface is a wired serial interface, a USB interface, Ethernet, CAN bus.

19. The method of claim 1, wherein besides the pure authorization information, the authentication includes information about the scope of the authorization, namely user information, time information, location information, permitted intervention depth.

20. The method of claim 1, wherein checking the access authorization in the authentication server takes into account not just the encrypted challenge but additionally information about the mobile device, in the form of hardware-specific and individualized information, and/or information about the user logged on at the mobile device and/or at the authentication server, and/or information from a token of such a user.

21. The method of claim 1, wherein the further device comprises at least the mentioned interface and also a data processing unit (CPU) with memory, and also at least one further functionality, in the form of a sensor, an output interface, including a display, or a loudspeaker, or a combination of such functionalities.

22. The method of claim 1, wherein on the authentication server and the device, private keys for the generation of challenge and respectively authentication and the verification of this encrypted information are present, and also corresponding associated public keys on the respective other device, wherein an incrementing number can be managed on the device.

23. The method of claim 9, wherein the keys, together with hardware-specific and individualized information of the device, are stored on a public blockchain.

24. The method of claim 1, wherein an identifier, in the form of a barcode or a QR code, is provided on the further device, which identifier can be read out by the mobile device and is used for the identification of the further device and for the communication with the authentication server by virtue of the corresponding device identifier being transmitted together with the challenge to the authentication server.

25. The system of claim 14, wherein the system comprises a server and/or an authentication server, at least one mobile device and a plurality of further devices.

26. The data processing program of claim 15 on a data memory, and, wherein the data processing program communicates on the mobile device with an output interface in the form of a display of the mobile device for communication with the user.
